(19) United States
(12) Patent Application Publication
(10) Pub. No.: US 2005/0113275 A1
(43) Pub. Date: May 26, 2005

(54) Water-soluble micromized aromatic liquid and a manufacturing method thereof

(76) Inventor: Yu-Chi Lin, Yonghe City (TW)

Correspondence Address: BRUCE H. TROXELL;SUITE 1404, 5205 LEESBURG PIKE, FALLS CHURCH, VA, 22041, US

(21) Appl. No.: 10/986,011

(22) Filed: Nov. 12, 2004

(30) Foreign Application Priority Data
Nov. 26, 2003 (TW) 92133260

(51) Int. Cl. C11D 17/00

(52) U.S. Cl. 510/417

(57) ABSTRACT

A water-soluble micromized aromatic liquid and a manufacturing method thereof. The water-soluble micromized aromatic liquid includes an essential oil extracted from natural plants, a refining agent and a regulating solution which is an aqueous solution of a non-ionized surfactant and soda powder. The above three components are fully mixed to form the water-soluble micromized aromatic liquid which can be fully resolved in water. The density of the aromatic liquid is approximately equal to the density of water. An over 1.5 megahertz ultrasonic aromatic atomizer can be used to synchronously vibrate the aromatic liquid and turn the aromatic liquid into micro-fog with a size under 3O μm.

### BACKGROUND OF THE INVENTION

The present invention is related to a water-soluble micromized aromatic liquid and a manufacturing method thereof. According to the manufacturing method, a natural essential oil is turned into a hydrophilic aromatic essential oil. An ultrasonic aromatic atomizer can be used to synchronously vibrate the aromatic essential oil and turn the aromatic essential oil into micro-fog with a size under 30 μm.

Natural essential oil is extracted from different trees, bushes, herbal plants, grasses and flowers. The natural essential oil has unique incense and can be utilized by way of breathing, massaging and application to achieve a relaxing or therapy effect. However, such essential oil is not water-soluble and can only float on the water. By means of heating the water, the essential oil can be volatilized to release incense. This is so-called incensing therapy. Alternatively, the essential oil can be resolved in an organic solvent such as alcohol and then burned to dissipate incense. This is so-called aromatic therapy.

The natural essential oil must be heated or burned to dissipate the incense. As a result, a fire or even explosion often takes place due to leakage of the essential oil or tilting down of the container. In addition, in the case that the essential oil is diluted with the organic solvent, the organic solvent can hardly fully burn. As a result, the organic solvent tends to volatilize into air. After breathing such gas, a user may contract cirrhosis.

In order to solve the above problems, the essential oil can be vibrated by means of ultrasonic wave to release incense of the essential oil. However, when vibrated by the ultrasonic wave, the molecules of the essential oil will be ruined. Also, the ultrasonic vibrator tends to damage. In the case that the essential oil is first diluted with alcohol or other organic solvent and then vibrated by ultrasonic wave to release incense, a user will breathe the vapor of organic solvent into human body. After a long term, the possibility of contracting cirrhosis will be increased. In the case that the essential oil is added to water, the essential oil of less density will float on the water. Therefore, it is impossible to synchronously vibrate the essential oil and the water molecules. As a result, the incensing effect is poor.

Therefore, it is tried by the applicant to turn the natural vegetable essential oil into hydrophilic essential oil of a density approximately equal to that of water. By means of an ultrasonic atomizer, the water and essential oil can be synchronously high-frequency vibrated to dissolve the liquid into micro-fog for human body to easily absorb.

### SUMMARY OF THE INVENTION

It is therefore a primary object of the present invention to provide a water-soluble micromized aromatic liquid and a manufacturing method thereof. The method for manufacturing the water-soluble micromized aromatic liquid includes steps of: (a) turning natural essential oil into hydrophilic essential oil, the natural essential oil being mixed with a refining agent in the ratio 1:1, then the mixture being stirred at 1500 r.p.m. for five minutes to form a 50±5% hydrophilic essential oil; (b) preparing a regulating solution, 6.6 mg soda powder (sodium carbonate or sodium bicarbonate) being resolved in 75 ml water, then 25 ml non-ionized surfactant being added into the solution and fully mixed therewith within ±5% modification range; and (c) mixing the hydrophilic essential oil of step (a) with the regulating solution of step (b), then water being added into the mixture and fully mixed therewith to form a water-soluble micromized aromatic essential oil of a certain concentration.

The water-soluble micromized aromatic liquid of the present invention is applicable to micro-aromatic fogging therapy. The incense of the aromatic liquid can be released by means of ultrasonic vibration. The present invention can be used more safely than the conventional aromatic therapy. The water-soluble micromized aromatic essential oil of the present invention contains no organic solvent so that it is harmless to human body. Moreover, it is unnecessary to heat or burn the essential oil so that the safety can be ensured. In addition, the water-soluble aromatic liquid of the present invention has a density approximately equal to that of water. Therefore, the aromatic liquid and water can be synchronously vibrated. When the frequency of the ultrasonic wave reaches 1.5 megahertz, the aromatic liquid will turn into micro-fog with a size under 30 μm. Therefore, a user can easily breathe the incense and absorb the incense into nasal mucous membrane to achieve better therapy effect.

The present invention can be best understood through the following description and accompanying drawings wherein:

### BRIEF DESCRIPTION OF THE DRAWINGS

FIG. 1 is a flow cart of the method for manufacturing the hydrophilic essential oil of the present invention;

FIG. 2 is a flow chart of the preparation of the regulating agent of the present invention; and

FIG. 3 is a flow chart of the method for manufacturing-the water-soluble micromized aromatic essential oil of the present invention.

### DETAILED DESCRIPTION OF THE PREFERRED EMBODIMENTS

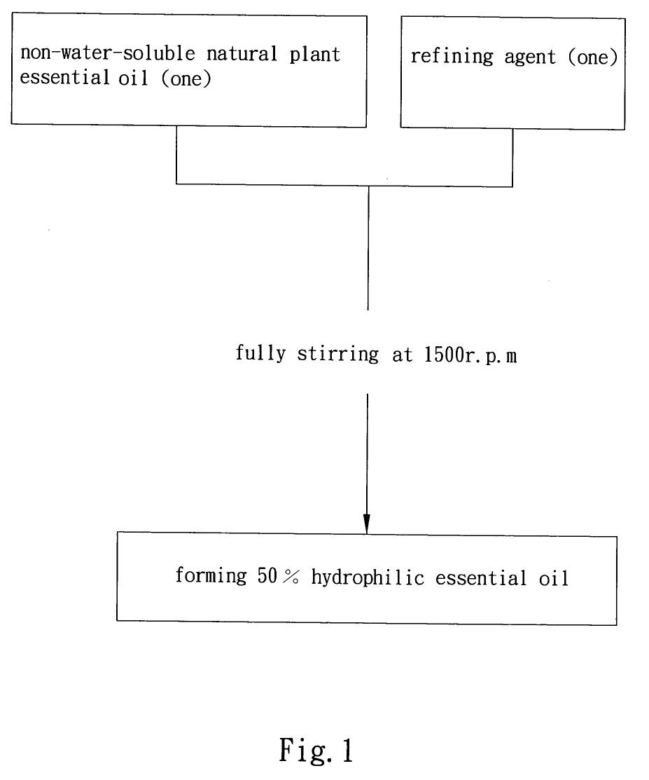

Please refer to FIGS. 1 to 3. The present invention is related to a micromized aromatic essential oil and a manufacturing method thereof. The method includes steps of:

(a) turning natural essential oil into hydrophilic essential oil, the natural essential oil being mixed with a refining agent in the ratio 1:1, then the mixture being stirred at 1500 r.p.m. for five minutes to form a 50±5% hydrophilic essential oil;

(b) preparing a regulating solution, 6.6 mg soda powder (sodium carbonate or sodium bicarbonate) being resolved in 75 ml water, then 25 ml non-ionized surfactant being added into the solution and fully mixed therewith within ±5% modification range; and

(c) mixing the hydrophilic essential oil of step (a) with the regulating solution of step (b), then water being added into the mixture and fully mixed therewith to form a water-soluble micromized aromatic essential oil of a certain concentration.

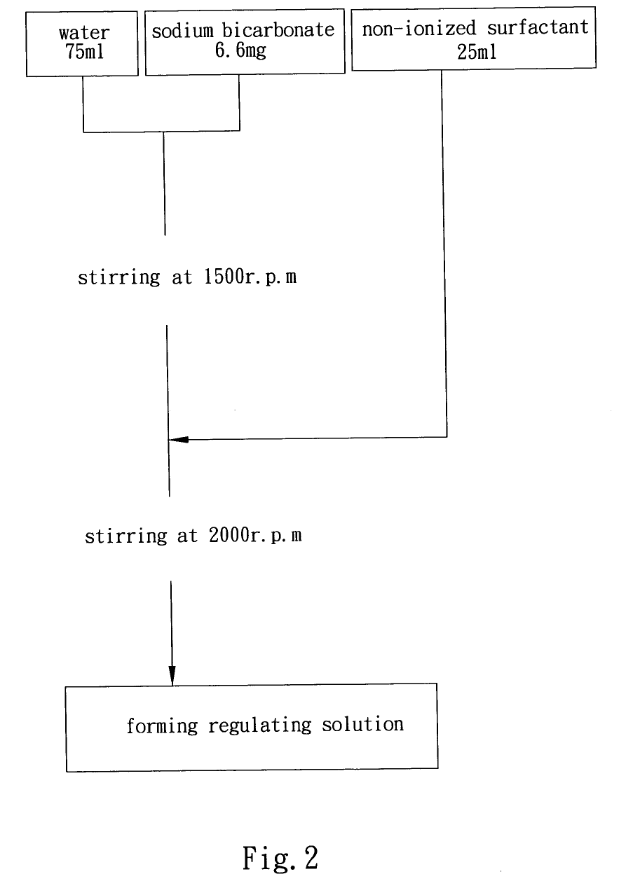

Referring to FIG. 2, the above refining agent is polysorbate or any other equivalent agent. This refining agent is a special surfactant capable of turning the natural essential oil into hydrophilic essential oil. The above regulating solution is made by means of resolving the soda powder such as sodium bicarbonate in the water and then stirring the mixture at 1500 r.p.m. for three minutes. Then a non-ionized surfactant is added into the solution and then the mixture is stirred at 2000 r.p.m. for five minutes to form a solution. The solution is the regulating agent.

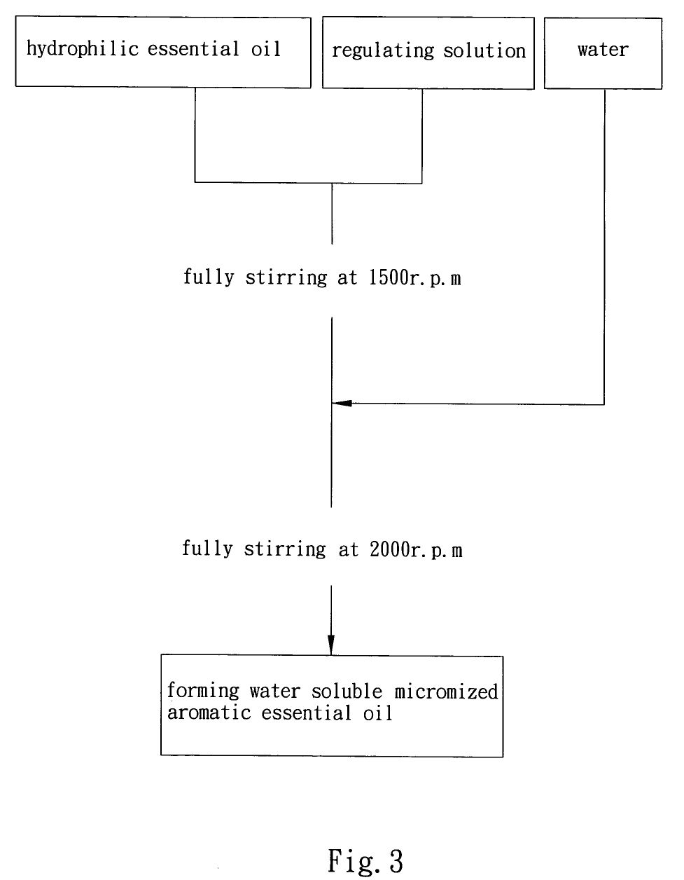

Referring to FIG. 3, in step (c), the amount of the added water is determined by the concentration of the water-soluble micromized aromatic liquid. For example, in the case that a water-soluble micromized aromatic liquid of 0.5 % concentration is desired, after 1 ml hydrophilic essential oil (50% hydrophilic essential oil) is mixed with 2 ml regulating solution, the mixture is stirred at 1500 r.p.m. for three minutes. Then 100 ml water is added into the solution and then the solution is stirred at 2000 r.p.m. for five minutes to form the water-soluble micromized aromatic liquid of 0.5% concentration.

The above hydrophilic essential oil can be used in a manner as follows:

A container is placed in an over 1.5 megahertz ultrasonic aromatic atomizer. After a certain amount of tap water is filled into the container, 1/100 water-soluble micromized aromatic essential oil is added into the water and properly evenly stirred. Then the aromatic atomizer is powered on to generate aromatic smog. Accordingly, an incense is released to the environment. In the case that the incense is insufficient, a suitable amount of water-soluble micromized aromatic essential oil can be readily added into the water. Reversely, in the case that a user feels that the incense is too thick, clean water can be added to dilute the solution.

In comparison with the conventional essential oil used in aromatic therapy or incensing therapy, the water-soluble micromized aromatic essential oil of the present invention has the following advantages:

1. In the method of the present invention, it is unnecessary to add alcohol or organic solvent into the essential oil. Therefore, it is harmless to human body to lastingly use the product of the present invention.

2. It is unnecessary to burn or heat the product of the present invention so that the safety can be ensured.

3. In the conventional aromatic therapy or incensing therapy, generally 3˜10% essential oil is used. In this method, only 0.3˜1% essential oil is used. The amount of the used essential oil is simply about 1/10 the amount of the essential oil used in the conventional aromatic therapy or incensing therapy so that the present invention is more economic.

4. The water-soluble micromized aromatic essential oil of the present invention will not stain the container. The water-soluble micromized aromatic essential oil of the present invention can be easily cleaned up by tap water.

The above embodiments are only used to illustrate the present invention, not intended to limit the scope thereof. Many modifications of the above embodiments can be made without departing from the spirit of the present invention.

1. A method for manufacturing a water-soluble micromized aromatic liquid, comprising steps of:
(a) turning natural essential oil into hydrophilic essential oil, the natural essential oil being fully mixed with a refining agent to form a hydrophilic essential oil;
(b) preparing a regulating solution, soda powder being resolved in water, then a non-ionized surfactant being added into the solution and fully mixed therewith to form the regulating agent; and
(c) mixing the hydrophilic essential oil of step (a) with the regulating solution of step (b), then water being added into the mixture and fully mixed therewith to form the water-soluble micromized aromatic liquid.

2. The method for manufacturing the water-soluble micromized aromatic liquid as claimed in claim 1, wherein the soda powder is sodium bicarbonate.

3. The method for manufacturing the water-soluble micromized aromatic liquid as claimed in claim 1, wherein the soda powder is sodium carbonate.

4. The method for manufacturing the water-soluble micromized aromatic liquid as claimed in claim 1, wherein the refining agent is polysorbate.

5. The method for manufacturing the water-soluble micromized aromatic liquid as claimed in claim 1, wherein the amount of the added water in step (c) is varied with the necessary concentration of the water-soluble micromized aromatic liquid.

6. The method for manufacturing the water-soluble micromized aromatic liquid as claimed in claim 4, wherein the amount of the added water in step (c) is varied with the necessary concentration of the water-soluble micromized aromatic liquid.

7. A water-soluble micromized aromatic liquid comprising:
an essential oil extracted from natural plants;
a refining agent; and
a regulating solution made by means of resolving soda powder in water and adding a surfactant added into the solution, the mixture being fully mixed to form the regulating solution.

8. The water-soluble micromized aromatic liquid as claimed in claim 7, wherein the soda powder is sodium bicarbonate.

9. The water-soluble micromized aromatic liquid as claimed in claim 7, wherein the soda powder is sodium carbonate.

10. The water-soluble micromized aromatic liquid as claimed in claim 7, wherein the refining agent is polysorbate.

11. The water-soluble micromized aromatic liquid as claimed in claim 7, wherein the regulating solution is an aqueous solution of soda powder and non-ionized surfactant.

12. The water-soluble micromized aromatic liquid as claimed in claim 10, wherein the regulating solution is an aqueous solution of soda powder and non-ionized surfactant.

13. The method for manufacturing the water-soluble micromized aromatic liquid as claimed in claim 2, wherein the refining agent is polysorbate.

14. The method for manufacturing the water-soluble. micromized aromatic liquid as claimed in claim 3, wherein the refining agent is polysorbate.

15. The method for manufacturing the water-soluble micromized aromatic liquid as claimed in claim 2, wherein the amount of the added water in step (c) is varied with the necessary concentration of the water-soluble micromized aromatic liquid.

16. The method for manufacturing the water-soluble micromized aromatic liquid as claimed in claim 3, wherein the amount of the added water in step (c) is varied with the necessary concentration of the water-soluble micromized aromatic liquid.

17. The water-soluble micromized aromatic liquid as claimed in claim 8, wherein the refining agent is polysorbate.

18. The water-soluble micromized aromatic liquid as claimed in claim 9, wherein the refining agent is polysorbate.

19. The water-soluble micromized aromatic liquid as claimed in claim 8, wherein the regulating solution is an aqueous solution of soda powder and non-ionized surfactant.

20. The water-soluble micromized aromatic liquid as claimed in claim 9, wherein the regulating solution is an aqueous solution of soda powder and non-ionized surfactant.
